(19) United States
(12) Patent Application Publication
(10) Pub. No.: US 2018/0372452 A1
(43) Pub. Date: Dec. 27, 2018

(54) BALLISTIC RESISTANT PANEL WITH EDGE SHOT ASSEMBLY AND METHOD

(71) Applicant: Central Lake Armor Express, Inc., Central Lake, MI (US)

(72) Inventors: Jonathan J. MacNeil, Rapid City, MI (US); Michael A. Criswell, Bellaire, MI (US); James A. O'Neal, Bellaire, MI (US)

(21) Appl. No.: 15/629,224

(22) Filed: Jun. 21, 2017

(51) Int. Cl. F41H 5/04; B32B 5/26

(52) U.S. Cl. CPC F41H 5/0478; B32B 5/24; B32B 5/26; F41H 5/0492

(57) ABSTRACT

A ballistic resistant panel assembly which includes a plurality of ballistic resistant plies positioned in a stack, wherein at least one ply of the plurality of ballistic resistant plies includes a larger dimension than other ballistic resistant plies positioned within the stack. The at least one ply comprises a bend and at least a portion of the bend is spaced apart from a peripheral edge of the at least one ply. Additionally, a method for assembling a ballistic resistant panel assembly is provided.

### FIELD

This disclosure relates to ballistic panel assemblies utilized as body armor, and more particularly to ballistic panels that include softer plies in the ballistic panel assembly.

### BACKGROUND

Ballistic resistant panels are worn to provide life-saving ballistic protection to a wearer. The ballistic resistant panels are positioned strategically to cover the wearer's body in order to optimize the wearer's protection. The panels can be worn in a wide variety of ways. For example, the panels can be positioned within a carrier and worn as a concealed body armor assembly or in some examples without a carrier as concealed body armor. In other examples, the ballistic resistant panels can be carried in a tactical carrier and worn as non-concealed or tactical body armor.

The ballistic panels are constructed of material selected from a wide range of ballistic resistant materials. The ballistic resistant panels can be constructed for example of one or more ballistic resistant components such as soft woven plies, soft laminate (unidirectional and/or non-unidirectional) plies or hard plate constructions.

Ballistic panels, in particular panels utilizing soft plies in the construction of the panel assembly, can be worn by the wearer and yet leave the wearer having some vulnerability to a ballistic projectile which strikes the ballistic resistant panel assembly on the strike face side along an edge portion of the strike face of the ballistic panel assembly. In the instance the ballistic resistant panel assembly includes soft plies, the strike face along the edge portion of the strike face of the ballistic resistant panel may not provide the wearer optimal protection. The soft plies which extend to the peripheral edge of the ballistic resistant panel assembly may not provide the ballistic resistant integrity from that location in contrast to the plies being position more centrally located on the ballistic resistant panel assembly away from the peripheral edge of the ballistic resistant panel.

With a ballistic impact occurring on the strike face near a peripheral edge of the ballistic resistant panel assembly, the impact tends to promote separation of the plies within the ballistic resistant panel assembly at that location. With a separation of plies occurring in this impact location, the separation of plies can facilitate the ballistic round exiting the ballistic resistant panel coverage of the wearer. With the panel coverage being compromised at the peripheral edge portion of the panel, injury can result to the wearer.

In an attempt to avoid a wearer being vulnerable to such injury from ballistic impacts on a strike face proximate to a peripheral edge of the ballistic resistant panel assembly, fabricators have installed, onto a ballistic resistant panel assembly, a border component positioned along the peripheral portion of the ballistic resistant panel assembly which extends about the peripheral edge of the ballistic resistant panel assembly. The border component overlies a portion of the strike face and the back face adjacent the peripheral edge of the ballistic resistant panel. This border component is a separately fabricated structure from that of the ballistic resistant panel assembly. The border component includes ballistic resistant material used in conjunction with an elastic material, wherein the border component fits over the edge of the ballistic resistant panel and encases the edge.

The elastic material of the border component confines and secures the border component onto the ballistic panel. With this border component not being part of the ballistic resistant panel, separate construction of the border component adds additional fabrication cost to the fabrication and assembly of the ballistic resistant panel. In addition, the portion of the border component that is positioned overlying, for example, the strike face side of the ballistic resistant panel provides a change in the strike face side surface topography. An alteration of the strike face side surface topography can make the presence of a concealed ballistic panel known to others. The revealing of the presence of a concealed ballistic resistant panel could jeopardize the security of the wearer.

There is a need to provide enhanced ballistic resistant integrity for ballistic resistant panel assemblies which contain soft ballistic resistant plies. In particular, providing increased integrity along the peripheral edge portion along and on the strike face side of a ballistic resistant panel assembly. The increased integrity has to be provided at a reasonable cost and the visual presence of this increased integrity has to be minimal so as to reduce an observable presence of the enhanced protection.

### SUMMARY

An example includes a ballistic resistant panel assembly which has a plurality of ballistic resistant plies positioned in a stack. At least one ply of the plurality of ballistic resistant plies has a larger dimension than other ballistic resistant plies positioned within the stack. The at least one ply includes a bend. At least a portion of the bend is spaced apart from a peripheral edge of the at least one ply.

Another example includes a method for assembling a ballistic resistant panel assembly which includes positioning a plurality of ballistic resistant plies in a stack wherein at least one ply of the plurality of ballistic resistant plies is of a larger dimension than other ballistic resistant plies positioned within the stack. The method further includes bending the at least one ply placing at least one bend in the at least one ply wherein at least a portion of the at least one bend is spaced apart from a peripheral edge of the at least one ply.

The features, functions, and advantages that have been discussed can be achieved independently in various embodiments or may be combined in yet other embodiments further details of which can be seen with reference to the following description and drawings.

### BRIEF SUMMARY OF THE DRAWINGS

FIG. 1 is a top planar view of a concealable ballistic resistant panel carrier for carrying a ballistic resistant panels;

FIG. 2 is a front elevation view of one of a plurality of ballistic resistant plies which has a larger dimension than other plies in a stack as seen for example in FIG. 3;

FIG. 3 is a perspective exploded view of a plurality of ballistic resistant plies in a stack;

FIG. 4 is a back elevation view of the plurality of ballistic resistant plies of FIG. 3 assembled and secured forming a ballistic resistant panel;

FIG. 5 is a front elevation view of the ballistic resistant panel of FIG. 4;

FIG. 6 is a cross section of a first embodiment of the ballistic resistant panel taken along line 6-6 of FIG. 5;

FIG. 7 is a second embodiment of the ballistic resistant panel of FIG. 6;

FIG. 8 is a third embodiment of the ballistic resistant panel of FIG. 6;

FIG. 9 is a fourth embodiment of the ballistic resistant panel of FIG. 6;

FIG. 10 is a fifth embodiment of the ballistic resistant panel of FIG. 6; and

FIG. 11 is a flow chart for assembling a ballistic resistant panel assembly.

### DESCRIPTION

As discussed earlier, there is a need to provide enhanced ballistic resistant integrity along the edge portion of the strike face side and back face side extending to the peripheral edge of the strike face side and back face side of a ballistic resistant panel assembly. The disclosure herein below discussed will provide enhanced integrity positioned along the edge portions of the strike face side and back face side and at the same time minimize the visual presence of the increased integrity.

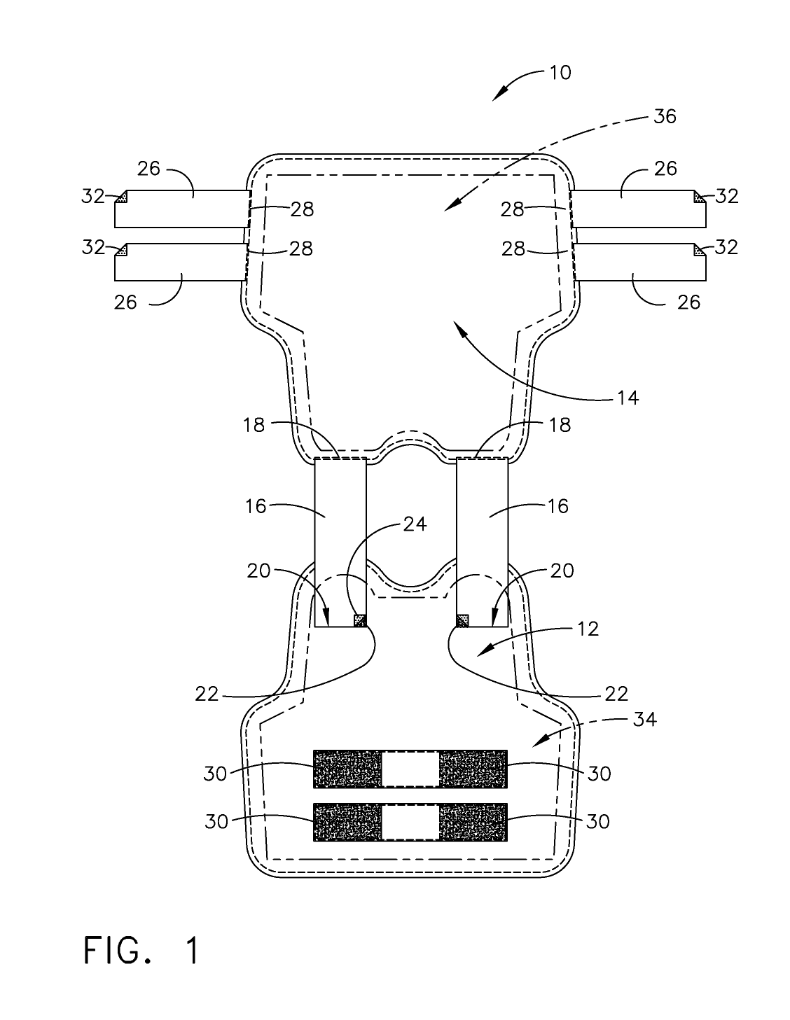

As discussed earlier, there are various ways to secure and position ballistic resistant panels to a wearer in order to provide strategic protection to a torso area of the wearer and in some instances to conceal the presence of the ballistic protection from others. In referring to FIG. 1, an example of a concealable carrier 10 is shown which will be an example for securing, carrying and positioning ballistic resistant panels to the wearer and in this instance in a concealed fashion. This concealable ballistic resistant garment arrangement is an example which provides both increased integrity and reduced visual presence of this increased integrity.

Concealable carrier 10 includes a front garment enclosure 12 and a back garment enclosure 14 which each contain and carry a ballistic resistant panel assembly. Concealable carrier 10 in this example, provides ballistic protection for the front portion of the torso of the wearer and the back portion of the torso of the wearer. Adjustably connecting the front garment enclosure 12 to back garment enclosure 14 with shoulder straps 16 employed in carrier 10. In this example, ends 18 of shoulder straps 16 are secured to back garment enclosure 14 by way of stitching or by way of other common securement methods. Opposing ends 20 of shoulder straps 16 are adjustably secured to front garment enclosure 12. In this example, panels of flexible loop type fasteners 22 are secured to front garment enclosure 12 and corresponding straps 16 carry in this example at least one panel of flexible hook fasteners 24, which when placed onto panel of flexible hook type fasteners 22, releasably secure strap 16 to front garment enclosure 12. This securement arrangement is similarly employed for both straps 16 as shown in FIG. 1. In this fashion, the wearer can vertically adjust front garment enclosure 12 and back garment enclosure 14 and thereby the ballistic resistant panel protection to a desired location on the wearer's torso.

Concealable carrier 10 is also secured to the wearer with use of side straps 26. Side straps 26 at one end 28 are secured to back garment enclosure 14 by way of stitching or by way of other common securement methods. In this example, panel of flexible loop type fasteners 30 are secured to front garment enclosure 12 and straps 26 each carry at least one panel of flexible hook type fasteners 32. With all four straps 26, in this example, positioned in a desired location, hook type fasteners 32 are engaged with the loop type fasteners 30 positioned at front garment enclosure 12 providing the wearer a snug fit of front and back garment enclosures 12, 14 of carrier 10 to the wearer's torso.

As shown in phantom in FIG. 1, front ballistic resistant panel assembly 34 is shown positioned within front garment enclosure 12 and back ballistic resistant panel assembly 36 is shown positioned within back garment enclosure 14. The structure and the assembling of ballistic resistant panels 34, 36 which are positioned within carrier 10 will be discussed in further detail herein. Front ballistic resistant panel or ballistic resistant panel 34 will be used as the example for this discussion. It should be understood that back ballistic resistant panel 36 can likewise be constructed as front ballistic resistant panel 34, which will be discussed herein.

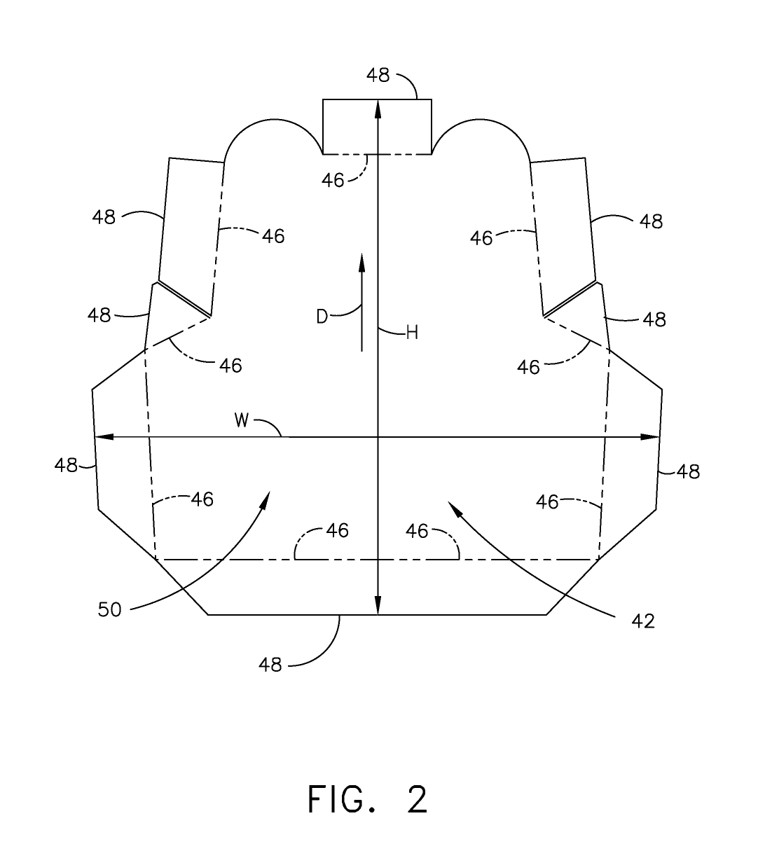

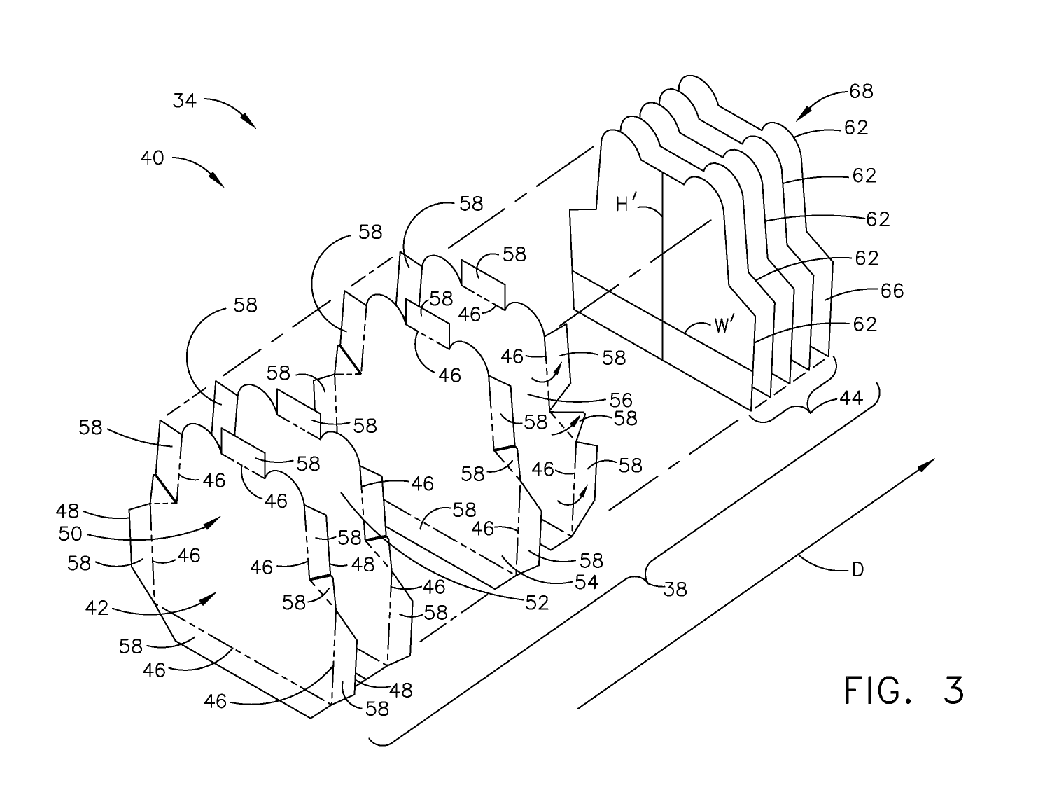

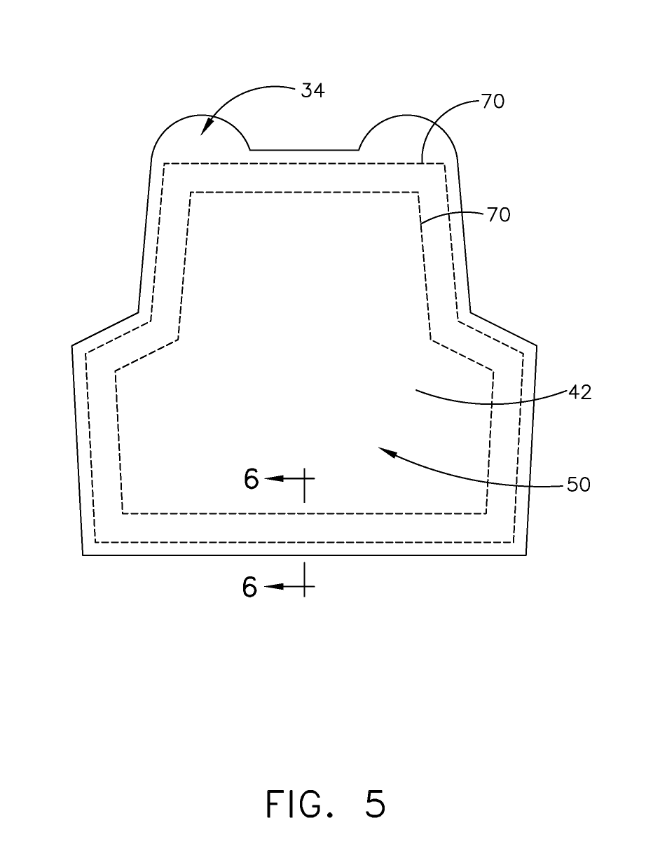

In referring to FIGS. 2-5, the structure and assembling of an example of ballistic resistant panel assembly 34 is shown. Ballistic resistant panel assembly 34, as seen in FIG. 3, includes a plurality of ballistic resistant plies 38 positioned in stack 40 forming ballistic resistant panel 34. At least one ply 42 of the plurality of ballistic resistant plies 38 comprises a larger dimension than other ballistic resistant plies 44 positioned in stack 40. As seen in FIG. 2 overall width dimension W of the at least one ply 42 and overall height dimension H of the at least one ply 42 are greater dimensions than corresponding dimensions of width D′ and height H′ of other ballistic resistant plies 44 as seen in FIG. 3. Ballistic resistant panel assembly 34 further includes at least one ply 42 including bend 46, as seen in FIGS. 2 and 3 wherein at least a portion of bend 46 is spaced apart from a peripheral edge 48 of the at least one ply 42.

A strike face side 50 of ballistic resistant panel assembly 34 includes the at least one ply 42 of the plurality of ballistic resistant plies 38. In this example, the at least one ply includes four plies which includes, ply 42, second ply 52, third ply 54 and fourth ply 56. These plies are positioned in overlying relationship to one another on the strike face side 50 of ballistic resistant panel assembly 34. In this example, plurality of plies 42, 52, 54 and 56 within the at least one ply have the same dimensions which are greater than the dimensions as discussed above with respect to ply 42 as compared to other ballistic resistant plies 44.

As discussed earlier herein, plurality of ballistic resistant plies 38 can be constructed in various ways. Examples of the construction of various ballistic resistant plies include a ply constructed of woven ballistic resistant fibers; a ply constructed of a laminate encasing unidirectional ballistic resistant fibers; or a ply constructed of a laminate encasing non-unidirectional ballistic resistant fibers etc.

Plurality of ballistic resistant plies 38 can include a variety of ply constructions which can for example include all plies being constructed of woven ballistic resistant fibers; the plies being selectively constructed of an assortment of woven ballistic fibers and laminate encasing ballistic resistant fibers of unidirectional and/or non-unidirectional ballistic resistant fibers. The fabricator can select the ply constructions based on the performance needed of a particular ballistic resistant panel assembly 34.

In this example, at least one ply 42 of the plurality of ballistic resistant plies 38 is constructed of woven ballistic resistant fibers as are the other plies within the at least one ply including second ply 52, third ply 54 and fourth ply 56. Woven ballistic fibers employed for construction of ballistic resistant plies 38 herein include the plies composed of one of an aramid, ultra-high molecular weight polyethylene, PBO (poly-p-phenylenebenzobisoxazole) or high strength nylon. These plies can also be selectively constructed of laminate encased fibers however utilizing woven fibers can provide additional manageability in bending and engaging these plies with the other ballistic resistant plies 44. The engaging of the at least one ply with the other ballistic resistant plies will be discussed in further detail below.

Each of the other ballistic resistant plies 44 of the plurality of ballistic resistant plies 38 are selectively constructed of one of woven ballistic resistant fibers as discussed above for the at least one ply or of a laminate encasement of ballistic resistant fibers. The laminate encasement of ballistic resistant fibers comprises one of unidirectional fibers or non-unidirectional fibers encase within a resin. In the example shown in FIG. 3, other ballistic resistant plies 44 are constructed of laminate encasement of ballistic resistant fibers which employ unidirectional fibers in each ply.

As seen in FIG. 3, ply 42, second ply 52, third ply 54 and fourth ply 56 of the at least one ply each includes bends 46 wherein at least a portion of bend 46 is spaced apart from peripheral edge 48 of each of plies 42, 52, 54 and 56. As will be discussed herein, bends 46 facilitate plies 42, 52, 54 and 56 to extend toward other ballistic resistant plies 44 so as to be positioned to surround peripheral edges 62 of other ballistic resistant plies 44 or such that a portion of plies 42, 52, 54, and 56 can be inserted in positions between other ballistic resistant plies 44. In either arrangement additional ballistic resistant integrity will be provided to the edge portion of ballistic resistant panel assembly 34 utilizing plies of assembly 34 to provide the additional ballistic resistant integrity without employing separately fabricated components. As will be appreciated, the use of the plies of ballistic resistant panel assembly 34, bending these plies, positioning and securing them as shown and described herein also provides minimizing the topography of the strike face side 50 and back side face 68 and minimizing the visual presence of the additional ballistic resistant integrity that has been provided.

At least one ply, which includes in this example plies 42, 52, 54 and 56 of the plurality of ballistic resistant plies 38 includes tab member 58 associated with the bend 46 wherein tab members 58 extend in a direction D away from the at least one ply, including plies 42, 52, 54 and 56 and toward other ballistic resistant plies 44 in this example, as seen in FIG. 3. In this example, each of plies 42, 53, 54 and 56 include tab members 58 positioned about a peripheral portion of each ply. Tab members 58 extend over and beyond at least one peripheral edge 62 of other ballistic resistant plies 44 positioned within stack 40.

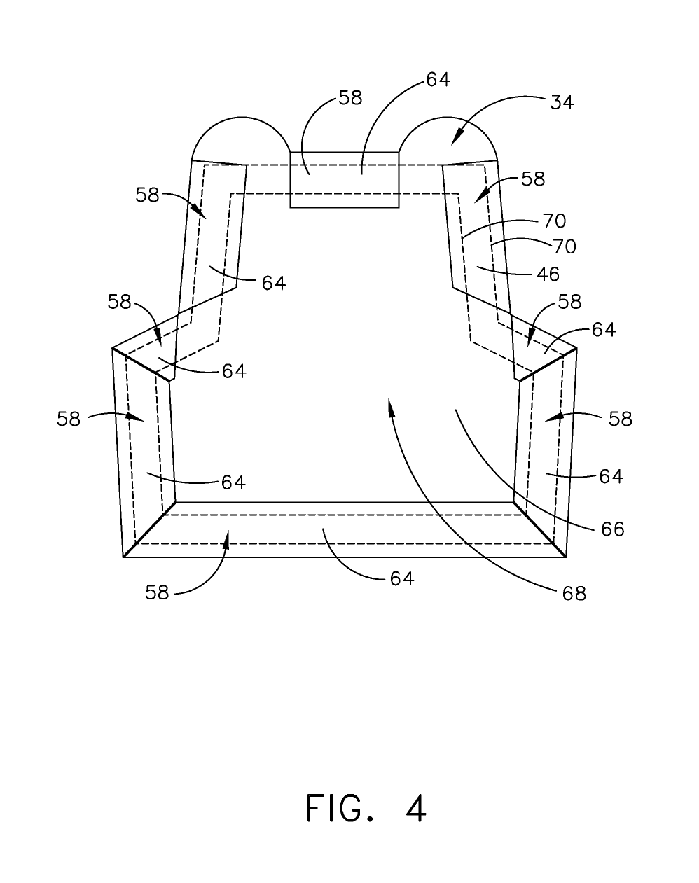

In one example, tab members 58 associated with bends 46 extend in Direction D over all peripheral edges 62 of other ballistic resistant plies 44, as seen in FIGS. 4-6, positioned within stack 40. Tab members 58 extend beyond other ballistic resistant plies 44 positioned within stack 40 such that portion 64 of tab members 58 are positioned to overlie a ballistic resistant ply 66 of other ballistic resistant plies 44, which is positioned on a back face side 68 of ballistic resistant panel 34. At least one row of stitches 70, in this example includes utilizing two rows, are positioned along ballistic resistant panel 34 securing together at least one ply, including in this example plies 42, 52, 54 and 56 of the plurality of ballistic resistant plies 38; other ballistic resistant plies 44; and portion 64 of tab members 58, which are from plies 42, 52, 54 and 56, are positioned overlying ballistic resistant ply 66, of the other ballistic resistant plies 44, positioned on back face side 68 of ballistic resistant panel 34. Other methodologies of securement can be employed such as bonding.

In another example, as seen in FIG. 7, tab members 58, which are from at least one ply in this example of plies 42, 52, 54 and 56, are associated with bends 46. Portion 64 of tab members 58 are positioned between two plies 72, 74 of other ballistic resistant plies 44. At least one row of stitches 76, in this example two rows of stitches are included, are positioned along the ballistic resistant panel 34 securing together at least one ply, in this example including plies 42, 52, 54 and 56 of the plurality of ballistic resistant plies 38; other ballistic resistant plies 44; and portion 64 of tab members 58, which are from plies 42, 52, 54 and 56 positioned between two plies 72, 74 of other ballistic resistant plies 44. Other methodologies of securement can be employed such as bonding.

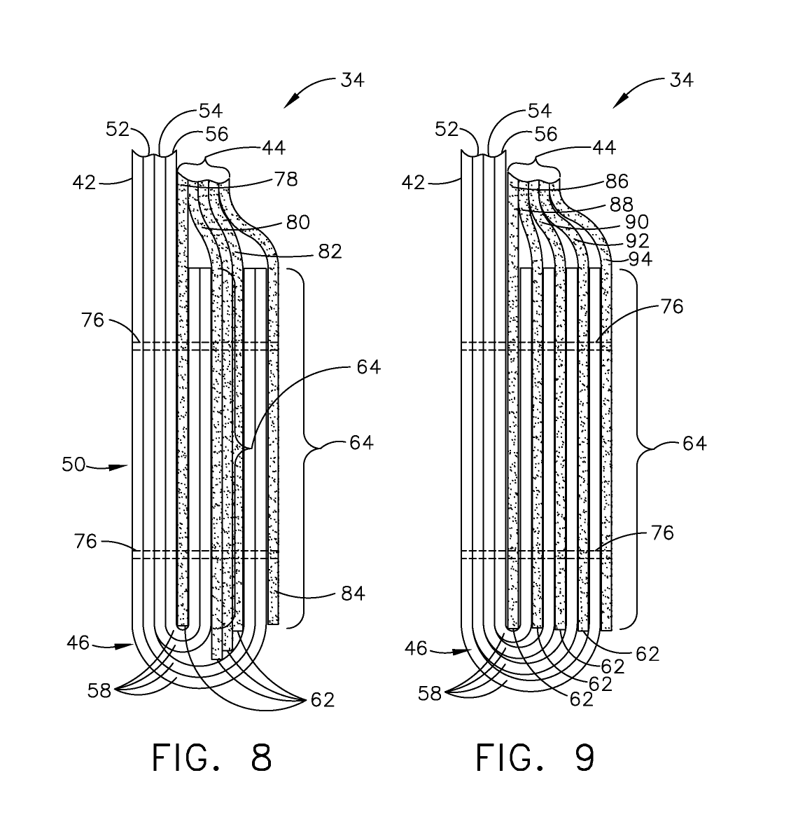

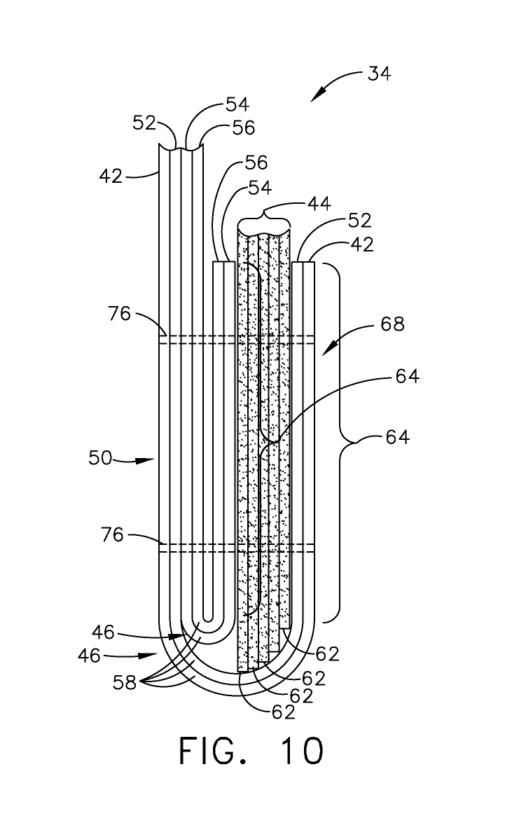

Other examples of positioning portion 64 of tab members 58 between plies of other ballistic resistant plies 44 is seen in FIGS. 8-9. In these examples, tab members 58 associated with bends 46 extend toward other ballistic resistant plies 44 wherein portion 64 of tab members 58, which are from plies 42, 52, 54 and 56, are interleaved in between plies within other ballistic resistant plies 44. In these examples at least one ply, including plies 42, 52, 54 and 56; other ballistic plies of 44 and portion 64 of tab members 58 and are secured together with using stitches. These assemblies provide additional ballistic resistant integrity and minimal visual presence of this enhanced ballistic resistant integrity. Again other methodologies of securement can be employed such as bonding.

In referring to FIG. 8, at least one ply, including plies 42, 52, 54 and 56 positioned on strike face side 50 have tab members 58 associated with bends 46 have portion 64 of tab members 58 from plies 42 and 52 positioned in between plies 78 and 80 of other ballistic resistant plies 44 and have portions 64 of tab members 58 from plies 54 and 56 positioned in between plies 82 and 84 of other ballistic resistant plies 44. At least one row of stitches 76, in this example two rows of stitches are included, are positioned along the ballistic resistant panel 34 securing together at least one ply, plies 42, 52, 54 and 56; other ballistic resistant plies 44 which includes at least plies 78, 80, 84 and 86 as well as portions 64 of tab members 58 which are from plies 42, 52, 54 and 56.

In referring to FIG. 9, at least one ply, including plies 42, 52, 54 and 56 positioned on strike face side 50 have tab members 58 associated with bends 46 wherein tab members 58 from: ply 42 has portion 64 positioned between plies 86 and 88 of other ballistic resistant plies 44; ply 52 has portion 64 positioned between plies 88 and 90 of other ballistic resistant plies 44; ply 54 has portion 64 positioned between plies 90 and 92 of other ballistic resistant plies 44; and ply 56 has portion 64 positioned between plies 92 and 94 of other ballistic resistant plies 44. At least one row of stitches 76, in this example two rows of stitches are included, are positioned along the ballistic resistant panel 34 securing together at least one ply, plies 42, 52, 54 and 56; other ballistic resistant plies 44 which includes plies 86, 88, 90 92 and 94 as well as portion 64 of tab members 58 which are from plies 42, 52, 54 and 56.

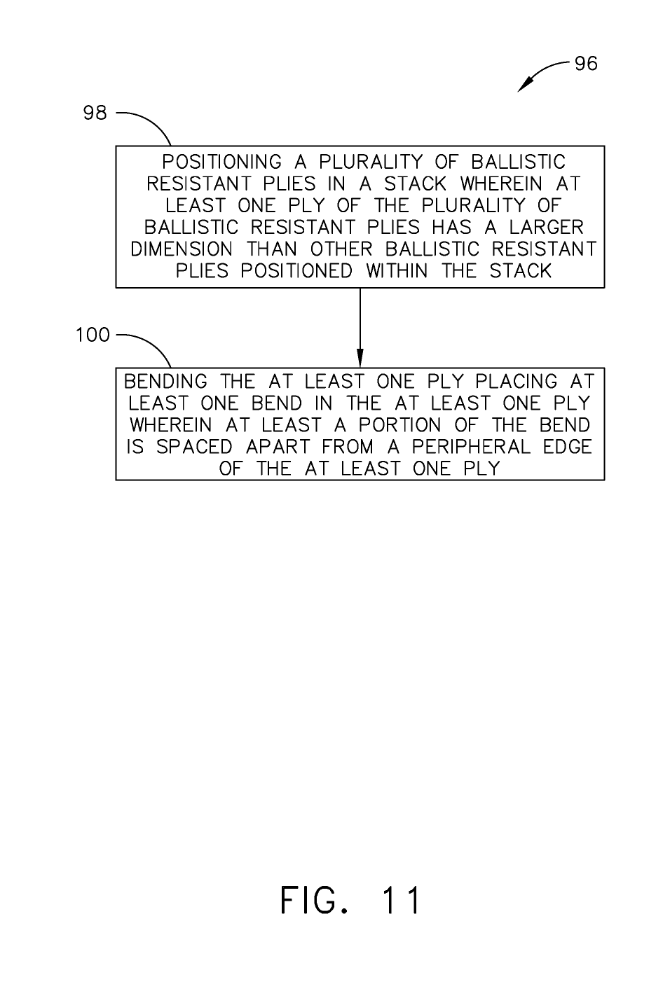

In referring to FIG. 10 shows another example of at least one ply, including plies 42, 52, 54 and 56 positioned on strike face side 50 have tab members 58 associated with bends 46 wherein tab members 58 from plies 54 and 56 extend with portion 64 of each ply 54 and 56 positioned to overlie other ballistic resistant plies 44 and tab members 58 from plies 42 and 52 extend over and beyond peripheral edges 62 of other ballistic resistant plies 44 and portion 64 of tab members 58 of plies 42 and 52 overlie other ballistic plies 44 at back face side 68 of ballistic resistant panel assembly 34.

Further is provided method 96 for assembling ballistic resistant panel assembly 34. Method 96, as seen in FIG. 11 includes step 98 of positioning a plurality of ballistic resistant plies 38 in stack 40 forming a ballistic resistant panel 34 wherein at least one ply of the plurality of ballistic resistant plies, which includes in this example ply 42, second ply 52, third ply 54 and fourth ply 56, includes a larger dimension as discussed above than other ballistic resistant plies 44 positioned within the stack 44, as seen in FIG. 3. Method 96 further includes step 100 of bending the at least one ply, in this example includes plies 42, 52, 54 and 56, placing at least one bend 46 in the at least one ply wherein at least a portion of the at least one bend 46 is spaced apart from a peripheral edge 48 of the at least one ply. In the example, shown in FIG. 3, the step of positioning also includes placing the peripheral edges of the other ballistic resistant plies 44 in alignment within stack 40.

The step 100 of bending of the at least one ply, which in this example includes plies 42, 52, 54 and 56, of the plurality of ballistic resistant plies 38 includes positioning a portion, as seen for example as tab member 58, of the at least one ply to extend over and beyond at least one peripheral edge 62 of other ballistic resistant plies 44 within stack 40. Step 100 of bending includes inserting an end portion, such as portion 64, of the portion or tab member 58 of the at least one ply, between two plies 72 and 74, such as seen for example in FIG. 7 of other ballistic resistant plies 44.

Method 96 further includes stitching at least one row of stitches 76, as seen in FIG. 7 for example, positioned along ballistic resistant panel 34 securing together the at least one ply, which in this example includes plies 42, 52, 54 and 56; other ballistic resistant plies 44 and the end portion or portion 64.

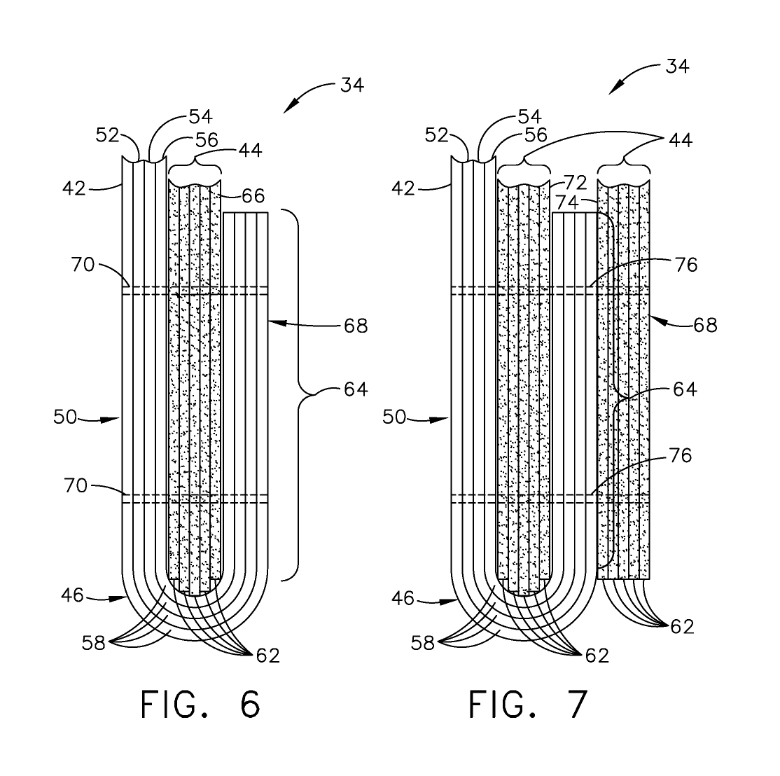

Step 100 of bending of the at least one ply, which in this example includes plies 42, 52, 54 and 56, of the plurality of ballistic resistant plies 38 includes positioning a portion, such as tab member 58, of the at least one ply to extend over and beyond each peripheral edge 62 of other ballistic resistant plies 44 within stack 40. Step 100 of bending includes positioning an end portion such as portion 64, of the portion or tab member 58 of the at least one ply, which in this example includes plies 42, 52, 54 and 56 to overlie a ballistic resistant ply 66, of other ballistic resistant plies 44, positioned on back face side 68 of ballistic resistant panel assembly 34, as seen in FIG. 6.

Method 96 further includes stitching at least one row of stitches 76 positioned along the ballistic resistant panel securing together the at least one ply, the other ballistic resistant plies 44 and the end portion such as portion 64, of portion or tab member 58, of the at least one of the plurality of ballistic resistant plies positioned overlying ballistic resistant ply 66 of other ballistic resistant plies 44 positioned on back face side 68 of ballistic resistant panel 34, as seen in FIG. 6.

While various embodiments have been described above, this disclosure is not intended to be limited thereto. Variations can be made to the disclosed embodiments that are still within the scope of the appended claims.

What is claimed:

1. A ballistic resistant panel assembly, comprising:
a plurality of ballistic resistant plies positioned in a stack assembly, wherein:
at least one ply of the plurality of ballistic resistant plies comprises a larger dimension than other ballistic resistant plies positioned within the stack; and
the at least one ply comprises a bend; and
at least a portion of the bend is spaced apart from a peripheral edge of the at least one ply.

2. The ballistic resistant panel assembly of claim 1, wherein a strike face side of the ballistic resistant panel assembly includes the at least one ply of the plurality of ballistic resistant plies.

3. The ballistic resistant panel assembly of claim 2, wherein the at least one ply includes a plurality of plies positioned in overlying relationship to one another on the strike side of the ballistic resistant panel assembly.

4. The ballistic resistant panel assembly of claim 3, wherein the plurality of plies within the at least one ply have the same dimensions.

5. The ballistic resistant panel assembly of claim 1, wherein the at least one ply of the plurality of ballistic resistant plies are constructed of woven ballistic resistant fibers.

6. The ballistic resistant panel assembly of claim 5, wherein the woven ballistic resistant fibers are composed of one of an aramid, ultra-high molecular weight polyethylene, PBO (poly-p-phenylenebenzobisoxazole) or high strength nylon.

7. The ballistic resistant panel assembly of claim 1 wherein each of the other ballistic resistant plies of the plurality of ballistic resistant plies is constructed of one of woven ballistic resistant fibers or a laminate encasement of ballistic resistant fibers.

8. The ballistic resistant panel assembly of claim 7, wherein the laminate encasement of ballistic resistant fibers comprises one of unidirectional fibers or non-unidirectional fibers.

9. The ballistic resistant panel assembly of claim 1 wherein the at least one ply of the plurality of ballistic resistant plies comprises a tab member associated with the bend wherein the tab member extends in a direction away from the at least one ply and extends over and beyond at least one peripheral edge of the other ballistic resistant plies positioned within the stack.

10. The ballistic resistant panel assembly of claim 9 wherein the tab member extends over all peripheral edges of the other ballistic resistant plies positioned within the stack.

11. The ballistic resistant panel assembly of claim 10 wherein the tab member extends beyond the other ballistic resistant plies positioned within the stack such that a portion of the tab member is positioned to overlie a ballistic resistant ply, of the other ballistic resistant plies, wherein the portion of the tab is positioned on a back face of the ballistic resistant panel.

12. The ballistic resistant panel assembly of claim 11 wherein at least one row of stitches are positioned along the ballistic resistant panel securing together the at least one ply of the plurality of ballistic resistant plies, the other ballistic resistant plies and the portion of the tab member positioned overlying the ballistic resistant ply of the other ballistic resistant plies and positioned on the back face side of the ballistic resistant panel.

13. The ballistic resistant panel assembly of claim 9 wherein a portion of the tab member is positioned between two plies of the other ballistic resistant plies.

14. The ballistic resistant panel assembly of claim 13 wherein at least one row of stitches are positioned along the ballistic resistant panel securing together the at least one ply of the plurality of ballistic resistant plies, the other ballistic resistant plies and the portion of the tab member positioned between the two plies of the other ballistic resistant plies.

15. A method for assembling a ballistic resistant panel assembly, comprising the steps of:
positioning a plurality of ballistic resistant plies in a stack wherein at least one ply of the plurality of ballistic resistant plies comprises a larger dimension than other ballistic resistant plies positioned within the stack; and
bending the at least one ply placing at least one bend in the at least one ply wherein at least a portion of the at least one bend is spaced apart from a peripheral edge of the at least one ply.

16. The ballistic resistant assembly of claim 15, wherein the positioning includes placing the peripheral edges of the other ballistic resistant plies in alignment within the stack.

17. The ballistic resistant assembly of claim 15, wherein:
bending of the at least one ply of the plurality of ballistic resistant plies includes positioning a portion of the at least one ply to extend over and beyond at least one peripheral edge of the other ballistic resistant plies within the stack; and
bending includes inserting an end portion, of the portion of the at least one ply, between two plies of the other ballistic resistant plies.

18. The ballistic resistant assembly of claim 17, further including stitching at least one row of stitches positioned along the ballistic resistant panel securing together the at least one ply, the other ballistic resistant plies and the end portion.

19. The ballistic resistant assembly of claim 15, wherein:
bending of the at least one ply of the plurality of ballistic resistant plies includes positioning a portion of the at least one ply to extend over and beyond each peripheral edge of the other ballistic resistant plies within the stack; and
bending includes positioning an end portion of the portion of the at least one ply to overlie a ballistic resistant ply, of the other ballistic resistant plies, positioned on a back face side of the ballistic resistant panel.

20. The ballistic resistant assembly of claim 19, further including stitching at least one row of stitches positioned along the ballistic resistant panel securing together the at least one ply, the other ballistic resistant plies and the end portion of the at least one of the plurality of ballistic resistant plies positioned overlying the ballistic resistant ply, of the other ballistic resistant plies, positioned on the back face side of the ballistic resistant panel.
